(19) United States
(12) Patent Application Publication
(10) Pub. No.: US 2014/0135079 A1
(43) Pub. Date: May 15, 2014

(54) ELECTRONIC DEVICE WITH BATTERY REPLACEMENT STRUCTURE FOR UNINTERRUPTED POWER

(71) Applicants: HONG FU JIN PRECISION INDUSTRY (ShenZhen) CO., LTD., (US); HON HAI PRECISION INDUSTRY CO., LTD., New Taipei (TW)

(72) Inventor: ZHI-QIANG LIANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/720,818

(22) Filed: Dec. 19, 2012

(30) Foreign Application Priority Data
Nov. 15, 2012 (CN) 201210459377.4

(51) Int. Cl. H04M 1/02

(52) U.S. Cl. CPC H04M 1/0262
USPC 455/572

(57) ABSTRACT

An electronic device includes a housing defining a battery compartment to receive a battery including many conductive terminals and a first engaging portion. Two sets of contacts are respectively mounted in the battery compartment at opposite ends, and each set of contacts is used to contact the terminals of the battery. Two second engaging portions are respectively mounted in the battery compartment at opposite ends, and each second engaging portion is rotatable in the battery compartment. Each second engaging portion is used to engage the first engaging portion of the battery to rotatably connect the battery to the housing, and the terminals of the battery stay in contact with one of the two sets of contacts during a rotation of the battery.

### BACKGROUND

1. Technical Field

The present disclosure relates to electronic devices, particularly, to an electronic device can function normally during replacing a to-be-drained battery with a new one.

2. Description of Related Art

When a battery of an electronic device (e.g., cellular phones) is in a low voltage condition, a user can choose to replace the to-be-drained battery with a new one. The electronic device has to be shut down first and then restarted after the new battery has been installed. It is useful if the electronic device need not to be shut down during the replacing of batteries.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of an electronic device according to one embodiment, with a cover detached from a housing.

FIG. 2 is an isometric view of the electronic device of FIG. 1, with the cover omitted and a battery removed from the housing.

FIG. 3 is an isometric exploded view of the electronic device of FIG. 1.

FIG. 4 is an isometric view showing the electronic device of FIG. 1 receiving power form two batteries.

### DETAILED DESCRIPTION

Embodiments of the present disclosure will be described with reference to the accompanying drawings.

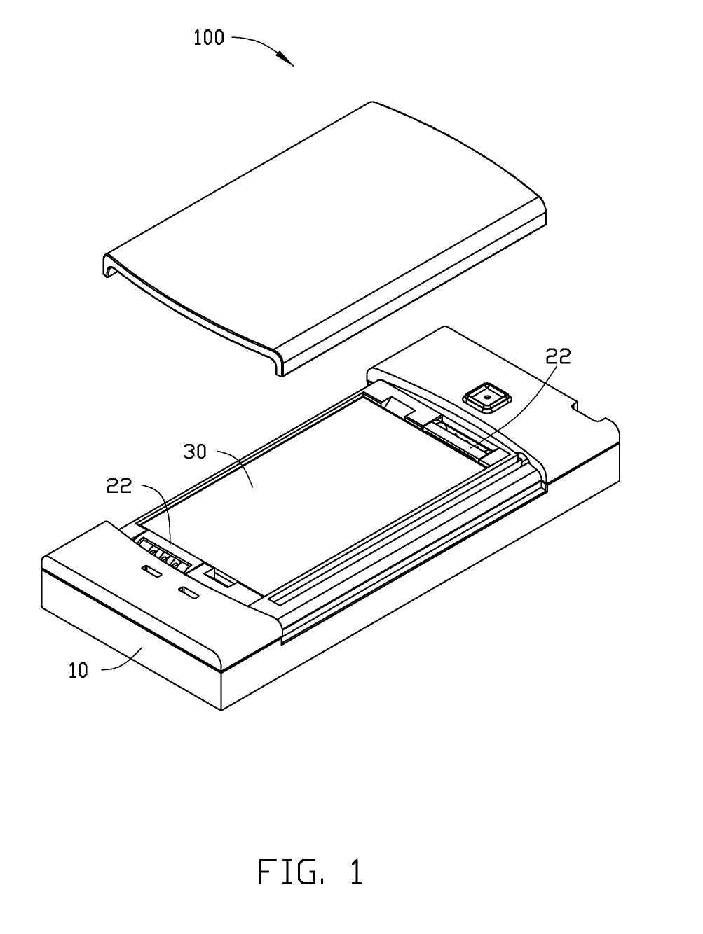

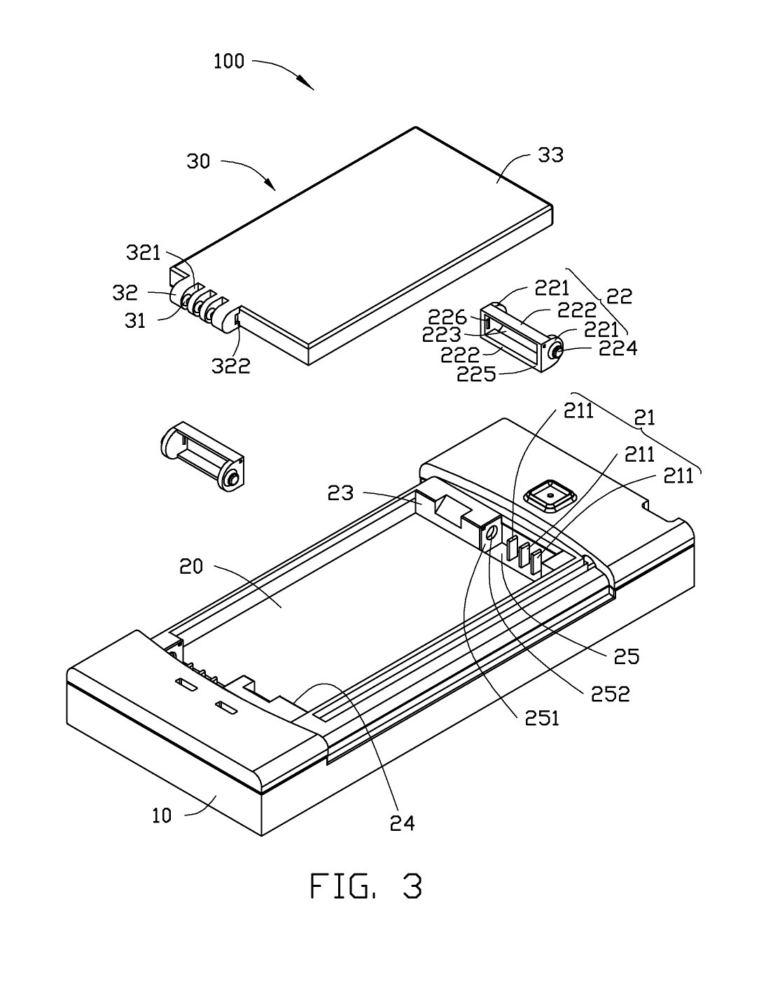

Referring to FIGS. 1-3, an electronic device 100 includes a housing 10 that defines a battery compartment 20. The battery compartment 20 includes a first end 23 and an opposite second end 24. Two sets of contacts 21 are respectively arranged at the first end 23 and the second end 24. The two sets of contacts 21 are electrically connected in parallel. In the embodiment, each set of contacts 21 are arranged in a line and are spaced apart from each other. Each contact 21 is a metal tab protruding from the bottom of the battery compartment 20. Each set of contacts 21 are located within a chamber 25.

Each chamber 25 includes two opposite sidewalls 251, each of which defines an axle hole 252. Two rotatable engaging members 22 are respectively arranged at the first end 23 and the second end 24. Each engaging member 22 includes two spaced sidewalls 221 and two connecting portions 222 that connect the sidewalls 221 together. The sidewalls and the connecting portions 222 cooperatively define a hollow space 223. Two axles 224 protrude from outer side of the sidewalls 221, respectively. Each axle 224 is rotatably fit into one axle hole 252, thus rotatably connecting the engaging member 22 to the housing 10.

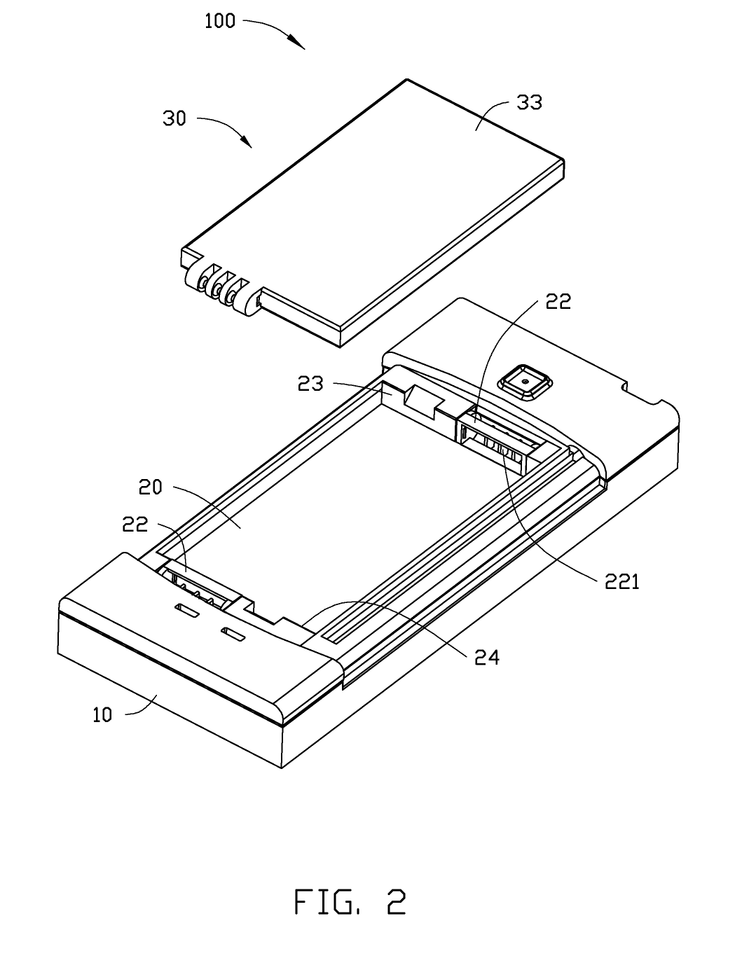

In the embodiment, the engaging members 22 is rotatable between a first position (FIG. 2) where an end surface 225 of the engaging members 22 is substantially perpendicular to the bottom of the battery compartment 20, and a second position where the end surface 225 is substantially parallel to the bottom of the battery compartment 20.

The battery 30 includes a body 33 and a protruding block 32 protruding from one side of the body 33. The protruding block 32 defines a number of parallel slots 321 that are spaced apart from each other. The battery 30 further includes a number of conductive terminals 31, each of which is mounted to a side surface of one slot 321.

The protruding block 32 can pass through the hollow space 223 of the engaging member 22, thus enabling the contacts 21 to be receive in the slots 321 and contact the terminals 31 when the side of the battery 30 where the protruding block 32 protrudes contacts the end surface 225 of the engaging member 22. In the embodiment, the protruding block 32 defines a recess 322 in one side, and the engaging member 22 includes a projection 226 on an inner side of one sidewall 221. The projection 226 can be fitted into the recess 322, thus locking the protruding block 32 in the hollow space 223.

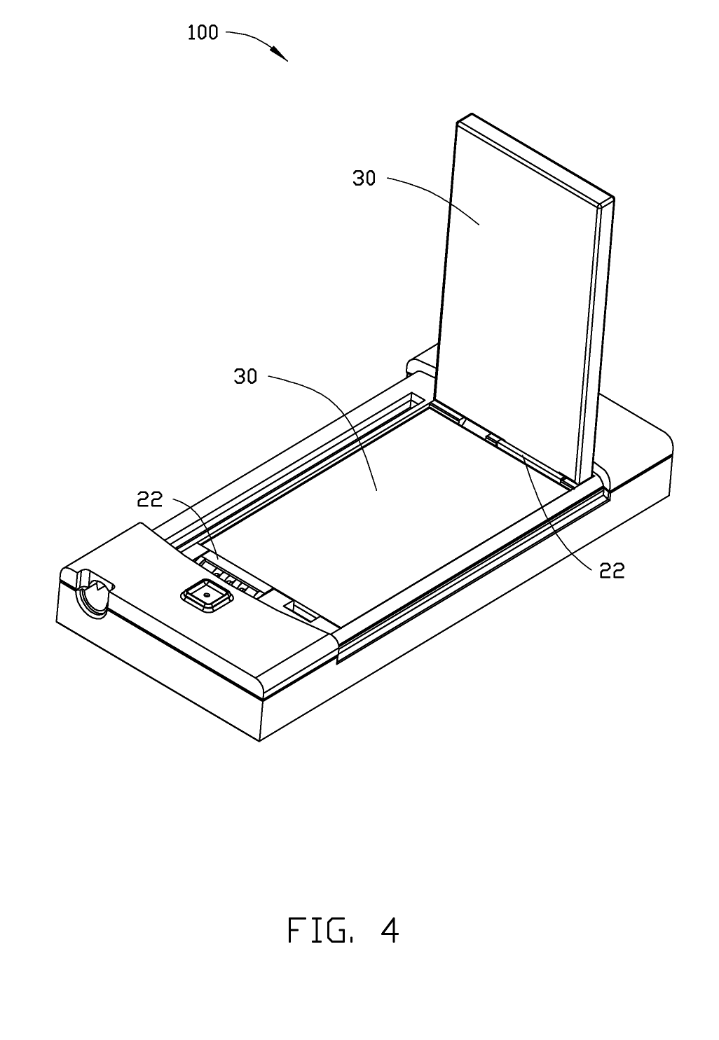

Referring to FIG. 4, when the battery 30 is at low voltage condition, a user can replace the battery 30 with a new one. Specifically, the battery 30 can be rotated 90 degrees from the position as shown in FIG. 1 to the position as shown in FIG. 4, with the terminals 31 staying in contact with the one set of contacts 21. Another engaging member 22 can then be rotated to the aforementioned second position, such that protruding block 32 of a new battery 30 can then be inserted into the hollow space 223 of the engaging member 22. The new battery 30 can then be rotated into the battery compartment 20. After that, the user can pull the original battery 30 to cause the projection 226 to move out of the recess 322, and remove the original battery 30 from the housing 10. During the whole process, the electronic device 100 can function normally because power provided to the electronic device 100 is not interrupted.

While various embodiments have been described and illustrated, the disclosure is not to be construed as being limited thereto. Various modifications can be made to the embodiments by those skilled in the art without departing from the true spirit and scope of the present disclosure as defined by the appended claims.

What is claimed is:

1. An electronic device comprising:
a housing defining a battery compartment configured to receive a battery, the battery comprising a plurality of terminals and a first engaging portion;
two sets of contacts respectively mounted in the battery compartment at opposite ends, each set of contacts being configured to contact the terminals of the battery; and
two second engaging portions respectively mounted in the battery compartment at opposite ends, each second engaging portion being rotatable in the battery compartment, each second engaging portion being configured to engage the first engaging portion of the battery to rotatably connect the battery to the housing, and the terminals of the battery staying in contact with one of the two sets of contacts during rotation of the battery.

2. The electronic device according to claim 1, wherein the first engaging portion is a protruding block protruding from one side of the battery, and each second engaging portion defines a hollow space to receive the protruding block.

3. The electronic device according to claim 2, wherein the protruding block defines a recess in a side thereof, and a sidewall of the hollow space includes a projection protruding therefrom, the projection is configured to be engaged with the recess to lock the protruding block in the hollow space.

4. The electronic device according to claim 2, wherein the protruding defines a plurality of slots, each terminal is arranged in one sidewall of one slot, each contact protrudes from a bottom of the battery compartment and is configured to be inserted into one of the slot.

5. The electronic device according to claim 4, wherein each contact is a metal tab.

6. An electronic device comprising:
a battery comprising a protruding block protruding from one side thereof and a plurality of terminals, the protruding block defining a plurality of slots, each terminal being fixed to a side surface of one of the slots;
a housing defining a battery compartment configured to receive the battery;
two sets of contacts protruding from a bottom of the battery compartment at opposite ends, each set of contacts being arranged in a line and spaced apart from each other, and each set of contacts being configured to contact the terminals of the battery; and
two engaging members respectively arranged at opposite ends of the battery compartment, each second engaging member being rotatable in the battery compartment, each second engaging member defining a hollow space, the protruding block being configured to pass through the hollow space, thereby enabling the terminals to contact one of the two sets of contacts and rotatably connecting the protrude block to the housing.

7. The electronic device according to claim 6, wherein each contact is a metal tab.

8. The electronic device according to claim 6, wherein the protruding block defines a recess in a side thereof, and a sidewall of the hollow space includes a projection protruding therefrom, the projection is configured to be engaged with the recess to lock the protruding block in the hollow space.
